(19) United States
(12) Patent Application Publication
(10) Pub. No.: US 2023/0186101 A1
(43) Pub. Date: Jun. 15, 2023

(54) TIME SERIES DATA ADVERSARIAL SAMPLE GENERATING METHOD AND SYSTEM, ELECTRONIC DEVICE, AND STORAGE MEDIUM

(71) Applicant: CHONGQING UNIVERSITY OF POSTS AND TELECOMMUNICATIONS, Chongqing (CN)

(72) Inventors: Xingping XIAN, Chongqing (CN); Tao WU, Chongqing (CN); Aidong XU, Guangzhou, Guangdong (CN); Yanbing LIU, Chongqing (CN); Yu WU, Chongqing (CN); Yunan ZHANG, Guangzhou, Guangdong (CN); Xuechun WANG, Chongqing (CN)

(73) Assignee: CHONGQING UNIVERSITY OF POSTS AND TELECOMMUNICATIONS, Chongqing (CN)

(21) Appl. No.: 17/924,991

(22) PCT Filed: Jun. 3, 2021
(86) PCT No.: PCT/CN2021/098066

§ 371 Date: Nov. 12, 2022

(30) Foreign Application Priority Data
Apr. 1, 2021 (CN) 202110354068.X

(51) Int. Cl. G06N 3/094

(52) U.S. Cl. CPC G06N 3/094

(57) ABSTRACT

A time series data adversarial sample generating method and system, an electronic device, and a storage medium, relating to the field of time series data processing. The method comprises: training a time series prediction model using original time series data (101); calculating a maximum value of a loss function in the time series prediction model by means of a stochastic gradient descent optimization strategy (102); determining corresponding noise according to the maximum value of the loss function (103); and superimposing the noise on the original time series data to generate a globally disturbed time series data adversarial sample (104). The method can significantly reduce the model accuracy under the condition of a small amount of data disturbance, has important significance for safe application of an industrial system, and has wide applicability and transferability.

The present application claims priority to Chinese Patent Application No. 202110354068.X, titled “TIME SERIES DATA ADVERSARIAL SAMPLE GENERATING METHOD AND SYSTEM, ELECTRONIC DEVICE, AND STORAGE MEDIUM”, filed on Apr. 1, 2021 with the Chinese Patent Office, which is incorporated herein by reference in its entirety.

### FIELD

A method and a system for generating a time series data adversarial sample, an electronic device and a storage medium are provided according to the present disclosure, mainly used for performing time series data prediction in the industrial field, and significantly affecting accuracy of a prediction model at a small data disturbance percentage.

### BACKGROUND

With the development of industrial internet and data acquisition technology, a large amount of time series data is accumulated in the industrial field. In fact, the time series data is a common type of data in the real world. The time series data is a group of numbers observed and arranged successively on a time axis, widely existing in anomaly detection, cost consumption, power signal, environmental perception and other scenarios. Due to internal regularity of the time series data, changes of values in the future may be predicted by analyzing and mining the time series data, which has important practical significance for industrial application.

In recent years, more and more researches focus on security of time series data models. At present, there are few researches on adversarial attacks related to time series, and few researches focus on adversarial attack of time series prediction models. Due to the adversarial feature of the conventional time series prediction models and deep learning, how to reduce performance of a time series prediction model to suppress reasoning of sensitive information in time series data is a problem to be urgently solved by those skilled in the art.

### SUMMARY

In view of the few adversarial samples exist in a conventional time series prediction model, an adversarial sample is generated based on privacy inference attacks and deep learning adversarial attacks based on the time series prediction models to realize privacy protection of time series data according to the present disclosure. Therefore, a method and a system for generating a time series data adversarial sample, an electronic device and a storage medium are provided according to the present disclosure.

According to a first aspect of the present disclosure, a method for generating a time series data adversarial sample is provided. The method includes: training a time series prediction model by using original time series data; calculating a maximum value of a loss function in the time series prediction model based on a stochastic gradient descent optimization algorithm; determining a noise based on the maximum value of the loss function; and superimposing the noise on the original time series data to generate a time series data adversarial sample with global disturbance.

In some implementations, the calculating a maximum value of a loss function in the time series prediction model based on a stochastic gradient descent optimization algorithm includes: determining, based on a direction opposite to a descent direction of a gradient, the maximum value of the loss function in a direction along which the loss function increases fastest.

In some implementations, the determining a noise based on the maximum value of the loss function includes: calculating a gradient of the loss function by using a symbolic function; determining a linear noise parameter based on a maximum disturbance and an iteration number; and determining a maximum value of a product of the linear noise parameter multiplied by the calculated gradient as the noise.

The linear noise parameter is equal to a ratio of the maximum disturbance to the iteration number.

In some implementations, after generating the time series data adversarial sample with global disturbance, the method further includes: calculating a first importance at each of time instants in the time series data adversarial sample and a second importance at each of time instants in the original time series data; calculating, at each of corresponding time instants, a distance between a first importance at the time instant and a second importance at the time instant; sorting distances at all corresponding time instants in a descending order to determine first several time instants; and replacing, by using data at the first several time instants in the generated time series data adversarial sample with global disturbance, data at corresponding time instants in the original time series data to generate a time series data adversarial sample with local disturbance.

According to a second aspect of the present disclosure, a system for generating a time series data adversarial sample is provided. The system includes a model training module, a data disturbance module, and a sample generation module. The model training module is configured to train a time series prediction model by using original time series data. The data disturbance module is configured to calculate a maximum value of a loss function in the time series prediction model based on a stochastic gradient descent optimization algorithm and determine a noise based on the maximum value of the loss function. The sample generation module is configured to superimpose the noise determined by the data disturbance module on the original time series data to generate a time series data adversarial sample with global disturbance.

In some implementations, the system further includes a data adjustment module. The data adjustment module is configured to select data at several time instants from the time series data adversarial sample with global disturbance, and replace data at corresponding time instants in the original time series data with the selected data to generate a time series data adversarial sample with local disturbance.

In some implementations, the system further includes a similarity calculation module. The similarity calculation module is configured to calculate a first importance degree at each of time instants in the time series data adversarial sample and a second importance at each of time instants in the original time series data, calculate, at each of corresponding time instants, a distance between a first importance of the time instant and a second importance at the time instant, and sort distances at all corresponding time instants in a descending order to determine first several time instants.

According to a third aspect of the present disclosure, an electronic device is further provided. The electronic device includes at least one processor and a memory coupled with the at least one processor. The memory stores a computer program. The computer program, when executed by the at least one processor, causes the processor to perform the method for generating a time series data adversarial sample according to the first aspect of the present disclosure.

According to a fourth aspect of the present disclosure, a computer readable storage medium is further provided. The computer readable storage medium stores a computer program. The computer program, when executed, performs the method for generating a time series data adversarial sample according to the first aspect of the present disclosure.

According to a fifth aspect of the present disclosure, a chip system is provided. The chip system includes a processor. The processor is configured to support an electronic device to perform the functions according to the first aspect or according to any embodiments of the first aspect.

In an embodiment, the chip system may further include a memory. The memory stores necessary program instructions and data of the electronic device. The chip system may include a chip, or include a chip and other independent devices.

For technical effects of the third to fifth aspects or any embodiments of the third to fifth aspects, one may refer to the technical effects of the first aspect or any embodiments of the first aspect, which are not repeated herein.

Compared with the conventional technology, the present disclosure has the following advantages.

(1) For the time series data prediction in the industrial field, an adversarial attack method is provided according to the present disclosure. With the method, accuracy of a model can be significantly reduced with little data disturbance, achieving great significance for safe application of industrial systems.

(2) The adversarial attack method according to the present disclosure has wide applicability and portability. The method can be directly applied to various time series data prediction models to perform adversarial attacks to reduce the prediction accuracy of the models.

(3) An adversarial sample generated according to the present disclosure for a certain target model can affect other prediction models with unknown structures and parameters.

### BRIEF DESCRIPTION OF THE DRAWINGS

FIG. 1 is a schematic diagram showing an overall frame of a time series data adversarial sample according to an embodiment of the present disclosure;

FIG. 2 is a flowchart of a method for generating a time series data adversarial sample according to an embodiment of the present disclosure;

FIG. 3 is a schematic diagram of generating an adversarial sample based on a gradient according to an embodiment of the present disclosure;

FIG. 4 is a flowchart of a method for generating a time series data adversarial sample according to another embodiment of the present disclosure;

FIG. 5 is a schematic structural diagram of a system for generating a time series data adversarial sample according to an embodiment of the present disclosure;

FIG. 6 is a schematic structural diagram of a system for generating a time series data adversarial sample according to another embodiment of the present disclosure;

FIG. 7 is a schematic structural diagram of a system for generating a time series data adversarial sample according to another embodiment of the present disclosure;

FIG. 8 is a schematic diagram showing prediction results of a time series prediction model at different disturbance percentages according to an embodiment of the present disclosure;

FIG. 9 is a schematic diagram showing effectiveness of adversarial attacks performed by different prediction models at different disturbance distances according to an embodiment of the present disclosure; and

FIG. 10 is a schematic diagram of verifying a method for generating a time series adversarial sample with local disturbance at different disturbance percentages.

### DETAILED DESCRIPTION OF THE EMBODIMENTS

Technical solutions in the embodiments of the present disclosure are clearly and completely described below in conjunction with the drawings of the embodiments of the present disclosure. Apparently, the embodiments described in the following are only some embodiments of the present disclosure, rather than all the embodiments. Any other embodiments obtained by those skilled in the art based on the embodiments in the present disclosure without any creative effort fall within the protection scope of the present disclosure.

In order to solve complex time series prediction problems, many methods based on deep learning models are proposed. The prediction model based on deep learning may capture and exploit dynamic correlations between multiple variables and take into account a mixture of a short-term repetition pattern and a long-term repetition pattern, achieving an accurate prediction. Recent researches show that an intelligent model based on a deep neural network is vulnerable to an adversarial attack by which the original data is slightly disturbed to generate an adversarial sample to cause the deep neural model to output a wrong result or a result expected by an attacker, affecting stability and security of an intelligent business system. In addition, although the time series data prediction is performed for providing the user with convenient services, an accurate time series data prediction may result in a risk of divulging privacy information in a case that predicted data is information that the user does not want to be discovered.

In order to reduce the risk of divulging privacy information caused by accurate prediction of time series data, a method and a system for generating a time series data adversarial sample, an electronic device and a storage medium are provided according to the present disclosure to generate a time series data adversarial sample with disturbance, thereby reducing accuracy of a time series prediction model.

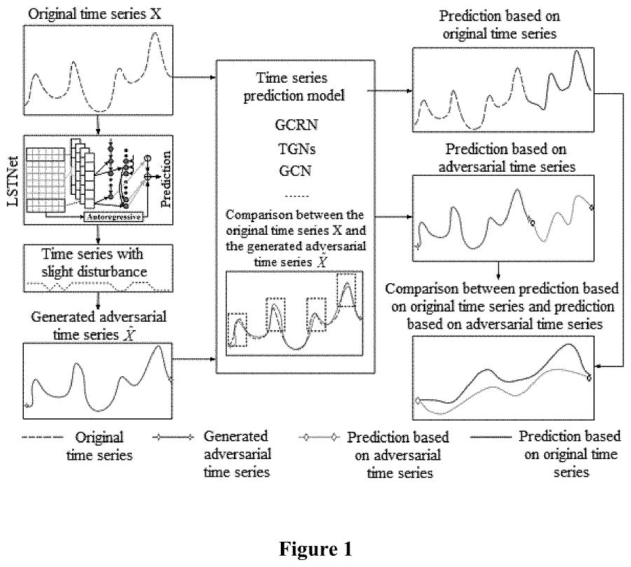

FIG. 1 is a schematic diagram showing an overall frame of a time series data adversarial sample according to an embodiment of the present disclosure. As shown in FIG. 1, original time series data is inputted to a time series prediction model according to the overall frame. The time series prediction model includes a CNN model, an LSTNet model, a MHANet model and an RNN model.

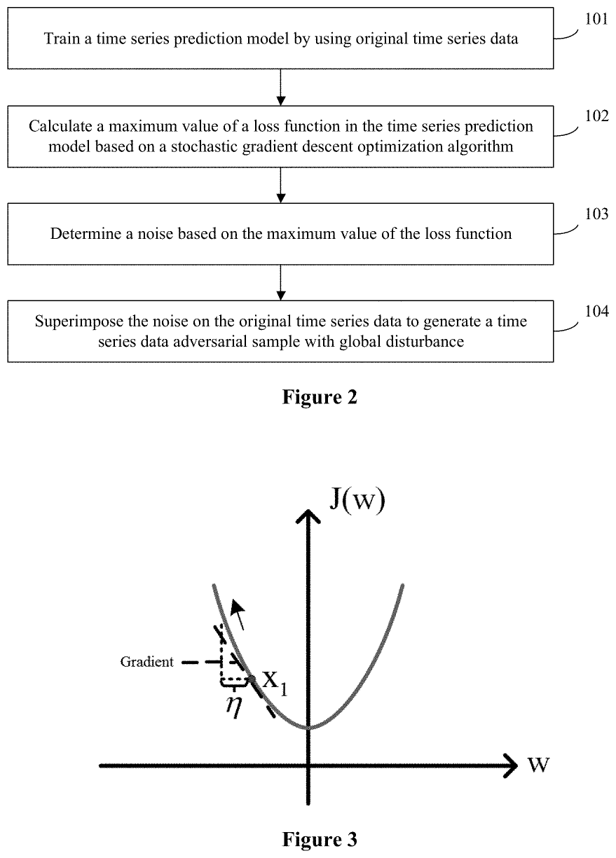

FIG. 2 is a flowchart of a method for generating a time series data adversarial sample according to an embodiment of the present disclosure. In this embodiment, a method for generating a time series data adversarial sample based on global disturbance is provided. As shown in FIG. 2, the method includes the following steps 101 to 104.

In step 101, a time series prediction model is trained by using original time series data.

In the embodiments of the present disclosure, the original time series data may be any conventional public or unpublished time series data. In this embodiment, three public electric power time series data sets are used. Each of the data sets is divided into a training set with a division ratio of 0.6, a verification set with a division ratio of 0.2 and a test set with a division ratio of 0.2. Specifically, the time series data sets include an Electricity data set, a Solar data set, and a Household_power_consumption data set.

1. For the Electricity data set, data samples in an original data set are collected every 15 minutes (values are in kW per 15 minutes). In data preprocessing, the data samples are divided by 4 to obtain a data set in kWh. The data set includes household electricity consumption data collected by 321 electricity meters from 2012 to 2014.

2. The Solar data set includes solar power generation records in 2006 which are obtained by performing collection every 5 minutes. Data collected from 137 photovoltaic power stations in Alabama is used in the embodiments of the present disclosure.

The Household_power_consumption data set is derived from a UCI public data set, which includes 2075259 pieces of measurement data collected from a household in Paris, France from December 2006 to November 2010. The original data includes 9 attributes (date, time, active power, reactive power, voltage, current intensity, power consumption of kitchen appliances collected by a No. 1 electricity sub meter, power consumption of laundry appliances collected by a No. 2 electricity sub meter, and power consumption of an electric water heater and an air conditioner collected by a No. 3 electricity sub meter). The sampling frequency is once per minute, and the data set is referred to as Household for short in the present disclosure.

In the embodiments of the present disclosure, in order to explore an adversarial attack of a time series data prediction model and how to generate a time series adversarial sample, it is required to determine a time series prediction model. At present, the common time series prediction models include a convolutional neural network (CNN), a recurrent neural network (RNN), and a multi-head attention network (MHANet).

(1) The convolutional neural network (CNN) is originally used to solve computer vision problems. Recent researches show that a good effect may be achieved in performing sequence prediction based on the CNN. The CNN includes a convolution layer, a pooling layer and a fully connected layer. The convolution layer may automatically extract features through a convolution kernel. The pooling layer performs a secondary sampling on the extracted features, and condenses a feature matrix with maintaining key information in the feature matrix. The above processing is useful for achieving a prediction result. The fully connected layer processes the data processed by the convolution layer and the pooling layer to obtain a prediction result. An output of the convolution layer is expressed as:

[symbol]

(x)=ReLU(W*X+b)

where ReLU represents an activation function, [symbol] eLU=max(0, x), and W represents a weight matrix.

The cConvolutional neural network (CNN) is originally used in the field of natural language processing to model text data. The text data has contextual relevance in time and space. The RNN may capture temporal relationship between time series. Based on features of adding feedback and memory to the network over time due to the recurrent connection in the RNN, a later time event is notified using an earlier time event, thereby obtaining long-term macroscopic information by using the RNN. A prediction result obtained by the RNN model at a time instant t is expressed as:

hₜ=σ(Wₓₕx₁+Wₕₕhₜ₋₁)

[symbol]

=g(W_{hy}xₜ)

where hₜ represents an output of a hidden layer at the time instant t, a represents an activation function of the hidden layer, and g represents an activation function of an output layer.

(3) Based on the multi-head attention network (MHANet), sequence features are extracted simultaneously in different representation spaces by using multiple Self-Attention combinations to obtain multiple Attentions, so as to finally obtain a merged result. With the MHANet, the model understands an input sequence from different perspectives to obtain a long-term trend, and the computational complexity is small. The Attention is calculated by using the following equation:

$$Attention ( Q , K , V ) = softmax ( \frac{{QK}^{T}}{\sqrt{{d}_{k}}} ) .$$

where Q represents a query vector, K represents a key vector, V represents a value vector, the three vectors are obtained by performing mapping on an input sequence X, and dk represents a dimension of a vector.

In addition to the above time series prediction models, in this embodiment, the conventional advanced deep neural network model of long-and-short-term time series network mode (LSTNet) model is used as a target model, and a time series adversarial sample is generated based on the target model to reduce the performance of the target model. The LSTNet is a deep learning model for performing multivariate time series prediction. An overall architecture of the LSTNet includes a convolution layer, a recurrent layer, a recurrent skip layer and a fully connected layer. The convolution layer is configured to extract local information. The recurrent layer is configured to capture long-term dependences. The recurrent skip layer is configured to solve very-long-term dependences. The fully connected layer is configured to output calculation. With the LSTNet, features of a long-term pattern and a short-term pattern can be extracted to obtain an accurate prediction. Models such as a Gated Recurrent Unit (GRU) and a Long Short Term Memory (LSTM) network are used for solving similar problems. However, in order to capture the very-long-term pattern, the GRU and the LSTM may have a problem of vanishing gradient, resulting in failure of prediction. Therefore, a recurrent-skip component is added in the LSTNet architecture to solve the problem. However, it is required to predefine the number of skipped hidden cells in adding a recurrent-skip layer in the LSTNet model, which is not conducive to aperiodic sequences. In order to overcome the disadvantage, an attention mechanism is introduced to the LSTNet for improvement. The LSTNet model decomposes the prediction result into a linear part and a nonlinear part. The nonlinear part is solved by the deep neural network. Based on the linear part, a local scale problem is solved. In the LSTNet model, an autoregressive (AR) model is used as a linear component. An output of the neural network and an output of the AR are accumulated to obtain a final prediction result of the LSTNet, which is expressed as:

[symbol]

=hₜ^{D}+hₜ^{L}

where [symbol] represents a final prediction of the time series prediction model at the time instant t, [symbol] represents an output of deep neural network model at the time instant t, and [symbol] represents an output of the autoregressive model at the time instant t.

In the LSTNet model, L1-Loss is used as a target function:

$$minimize {\sum }_{t ∈ {Ω}_{train}} {\sum }_{i = 0}^{n - 1} \vert {Y}_{t , i} - {Y}_{t - h , i}^{′} \vert .$$

L1-Loss is not easily affected by an observation value with a large error, that is, L1-Loss has strong robustness to an abnormal time series value. Therefore, the LSTNet serves as the target model in this embodiment.

In step 102, a maximum value of a loss function in the time series prediction model is calculated based on a stochastic gradient descent optimization algorithm.

In order to make the time series prediction model generalizable, the time series prediction model is trained based on the stochastic gradient descent optimization algorithm in this embodiment. A weight is continuously updated based on a gradient to minimize the loss function. The process is repeated to converge the weight, and then a final weight is obtained. In order to attack the time series prediction model, the time series data is disturbed based on information of the gradient, so that the time series prediction model outputs a wrong result, that is, a time series data adversarial sample. The optimization the time series prediction model against attacks may be expressed as:

[symbol]

max J(\hat{X},Y)s.t.∥\hat{X}−X∥ₙₒᵣₘ≤ε

where J represents the loss function of the time series prediction model where L1-Loss is used as the loss function in the embodiments of the present disclosure, norm represents a matrix norm which is usually configured as a 2-norm or a ∞ norm, and ε represents data disturbance.

In the present disclosure, the time series adversarial sample is generated based on the information about the gradient to deceive the time series prediction model, thereby reducing the performance of the model. In training the time series prediction model, a minimum value of the loss function is determined along a direction opposite to a direction of the gradient. If it is required to attack the model, opposite steps may be performed. As shown in FIG. 3, the abscissa represents an independent variable in the loss function, that is, the weight w of the model; and the ordinate represents a value J(w) of the loss function J. In a direction along which the loss function increases fastest, that is, in the direction indicated by the arrow shown in

FIG. 3, the maximum value of the loss function may be determined quickly. [symbol] represents a linear accumulation of noise. A linear function of the time series prediction model is expressed as [symbol] (W•X)=f(W•X+W•η). When the gradient update direction is the same or opposite to the disturbance direction, a value of [symbol] reaches a maximum value or a minimum value where the weight W is obtained based on the gradient update direction, resulting in that an output of the time series prediction model exceeds a normal range and the time series prediction model outputs a wrong prediction result.

In step 103, a noise is determined based on the maximum value of the loss function.

In this embodiment, since the original time series data X, the target sequence Y, the number of iterations K, the maximum disturbance E and the linear noise parameter

$$α = \frac{ε}{K} .$$

have been inputted in the above steps, a gradient [symbol] J(X, Y) of the loss function is firstly calculated in the iterative process, and the noise is obtained by using the equation of [symbol] =a•sign(∇ₓJ(X, Y)).

In step 104, the noise is superimposed on the original time series data to generate a time series data adversarial sample with global disturbance.

In this step, η represents the noise, and X represents the original time series data. Therefore, the time series data adversarial sample with global disturbance is expressed as:

[symbol]

=X+η

In the method for generating a time series data adversarial sample with global disturbance according to this embodiment, the original time series data X, the target sequence Y, the number of iterations K, the maximum disturbance ε and

$$α = \frac{ε}{K} .$$

are inputted, and the time series data adversarial sample [symbol] based on global disturbance and the trained time series prediction model f are outputted. In the process, the time series prediction model f is trained by using the original time series X In each of iteration processes, a gradient loss between the original time series data X and the target sequence Y is calculated by using the loss function. Based on the gradient loss, a current noise η is determined. The noise η is superimposed on the original time series data X to obtain the time series data adversarial sample [symbol] based on global disturbance.

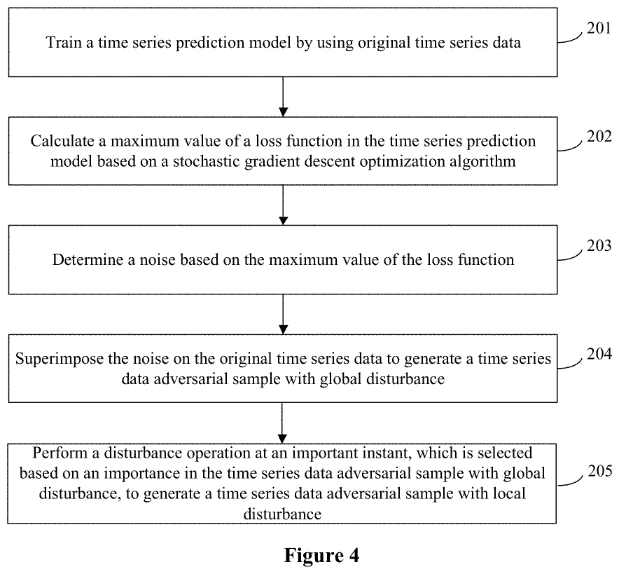

FIG. 4 is a flowchart of a method for generating a time series data adversarial sample according to another embodiment of the present disclosure. According to this embodiment, a method for generating a time series data adversarial sample with local disturbance is provided. As shown in FIG. 4, the method includes the following steps 201 to 205.

In step 201, a time series prediction model is trained using original time series data.

In step 202, a maximum value of a loss function in the time series prediction model is calculated based on a stochastic gradient descent optimization algorithm.

In step 203, a noise is determined based on the maximum value of the loss function.

In step 204, the noise is superimposed on the original time series data to generate a time series data adversarial sample with global disturbance.

In step 205, a disturbance operation is performed at an important instant, which is selected based on an importance in the time series data adversarial sample with global disturbance, to generate a time series data adversarial sample with local disturbance.

In this embodiment of the present disclosure, after the time series data adversarial sample with global disturbance is generated, a first importance at each of time instants in the time series data adversarial sample and a second importance at each of time instants in the original time series data are calculated; at each of corresponding time instants, a distance between a first importance at the time instant and a second importance at the time instant is calculated, and distances at all corresponding time instants are sorted in a descending order to determine first several time instants; data at the first several time instants in the generated time series data adversarial sample with global disturbance is used to replace data at corresponding time instants in the original time series data to generate the time series data adversarial sample with local disturbance.

Although attacks can be resisted by using the method according to the above embodiments, the process of performing disturbance operation on a value at each of time instants results in a high cost and is easy to be detected. Therefore, based on the generated adversarial sample according to the first embodiment of the present disclosure, optimization is performed based a feature importance algorithm in this embodiment.

With the feature importance, contributions of inputted features to the model are determined, and then an optimal feature subset is obtained based on selected features. In the method according to the present disclosure, it is assumed that values at different time instants in the adversarial sample have different effects on the result of the model. Based on the first embodiment, the disturbance operation is performed at important time instants in the adversarial sample to reduce a distance between the time series [symbol] after the disturbance operation and the original time series X Specifically, a method for determining an importance of a time instant in a time series is provided according to this embodiment. With the method, a distance between [symbol] and Y is calculated. A larger distance indicates a great contribution of [symbol] . Based on a disturbance percentage P, the time series data at first top P % most important time instants are selected to replace the time series data at corresponding time instants in the original time series, thereby obtaining the time series data adversarial sample with local disturbance.

In the method for generating a time series data adversarial sample with local disturbance according to this embodiment, the original time series data X with a length of T, the target sequence Y, the adversarial sample [symbol] =[\hat{x}₁, \hat{x}₂, . . . , \hat{x}ₗ, . . . , \hat{x}_{T}], the time series prediction model f and the disturbance percentage P are inputted, and the time series data adversarial sample [symbol] based on local disturbance is outputted. In the above process, an importance of each of time instants in the adversarial sample [symbol] =f(\hat{x}₁, \hat{x}₂, . . . , \hat{x}ₗ, . . . , \hat{x}_{T}),t=(1, 2, 3, . . . , T) is calculated, where Ŷₜ′ includes an original time series data without disturbance at a time instant t and prediction values with disturbance at other (T-1) time instants. A distance between an adversarial sample and a target sequence at each of time instants is calculated by using the equation of [symbol] =∥Y−Ŷₜ′∥₂. Distances [symbol] distance, at all corresponding time instants are sorted in a descending order. The first P % time instants are selected based on a sorting result. The time series data at time instants in the original time series data is replaced with the adversarial time series sample selected at the corresponding first P % time instants to obtain locally disturbed adversarial samples [symbol] .

Like many other prediction tasks, in the time series prediction model according to the present disclosure, [symbol] -Loss and [symbol] -Loss may be selected as the loss function, where

$$L 1 - Loss = {\sum }_{i = 0}^{n} \vert {y}_{i} - f ( {x}_{i} ) \vert , and L 2 - Loss = {\sum }_{i = 0}^{n} {( {y}_{i} - f ( {x}_{i} ) )}^{2} .$$

It can be seen that for outliers, an error may be squared by using [symbol] -Loss, so that a large error is to be obtained. [symbol] -Loss is robust to the outliers and is usually not affected by the outliers. However, [symbol] -Loss is sensitive to the outliers in the data set. For [symbol] -Loss, the weight of the model is to be adjusted based on the values of the outliers.

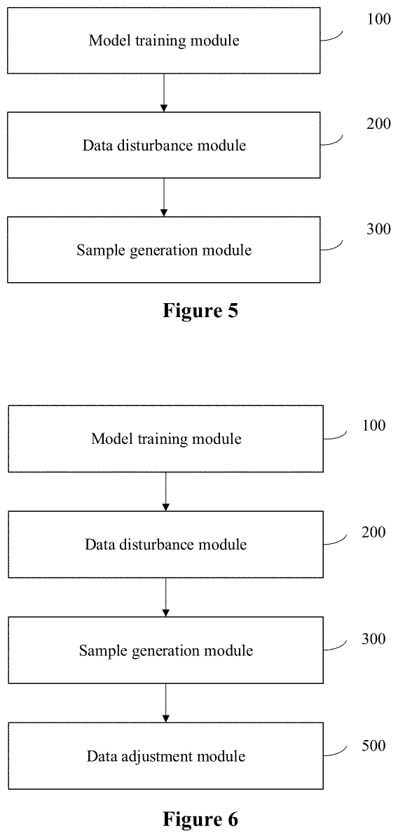

FIG. 5 is a schematic structural diagram of a system for generating a time series data adversarial sample according to an embodiment of the present disclosure. As shown in FIG. 5, the system includes a model training module 100, a data disturbance module 200 and a sample generation module 300.

The model training module 100 is configured to train a time series prediction model by using original time series data.

The data disturbance module 200 is configured to calculate a maximum value of a loss function in the time series prediction model based on a stochastic gradient descent optimization algorithm and determine a noise based on the maximum value of the loss function.

The sample generation module 300 is configured to superimpose the noise determined by the data disturbance module on the original time series data to generate a time series data adversarial sample with global disturbance.

FIG. 6 is a schematic structural diagram of a system for generating a time series data adversarial sample according to another embodiment of the present disclosure. As shown in FIG. 6, the system includes a model training module 100, a data disturbance module 200, a sample generation module 300, and a data adjustment module 500.

The model training module 100 is configured to train a time series prediction model by using original time series data.

The data disturbance module 200 is configured to calculate a maximum value of a loss function in the time series prediction model based on a stochastic gradient descent optimization algorithm and determine a noise based on the maximum value of the loss function.

The sample generation module 300 is configured to superimpose the noise determined by the data disturbance module on the original time series data to generate a time series data adversarial sample with global disturbance.

The data adjustment module 500 is configured to select data at several time instants from the time series data adversarial sample with global disturbance and replace data at corresponding time instants in the original time series data with the selected data to generate a time series data adversarial sample with local disturbance.

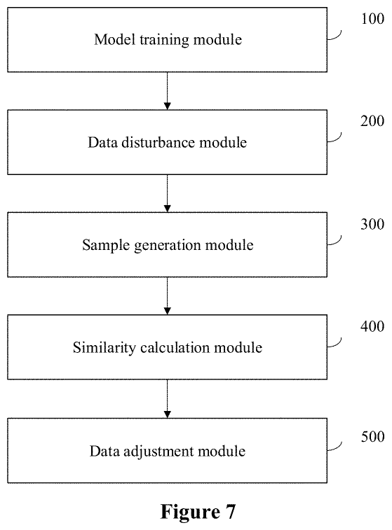

FIG. 7 is a schematic structural diagram of a system for generating a time series data adversarial sample according to an embodiment of the present disclosure. As shown in FIG. 7, the system includes a model training module 100, a data disturbance module 200, a sample generation module 300, a similarity calculation module 400 and a data adjustment module 500.

The model training module 100 is configured to train a time series prediction model by using original time series data.

The data disturbance module 200 is configured to calculate a maximum value of a loss function in the time series prediction model based on a stochastic gradient descent optimization algorithm and determine a noise based on the maximum value of the loss function.

The sample generation module 300 is configured to superimpose the noise determined by the data disturbance module on the original time series data to generate a time series data adversarial sample with global disturbance.

The similarity calculation module 400 is configured to calculate a first importance at each of time instants in the time series data adversarial sample and a second importance at each of time instants in the original time series data, calculate, at each of corresponding time instants, a distance between a first importance at the time instant and a second importance at the time instant, and sort distances at all corresponding time instants in a descending order to determine first several time instants.

The data adjustment module 500 is configured to select data at several time instants from the time series data adversarial sample with global disturbance and replace data at corresponding time instants in the original time series data with the selected data to generate a time series data adversarial sample with local disturbance.

It should be noted that information interaction between modules/units of the above apparatus and implementation process of the apparatus are based on the same idea as the method embodiments of the present disclosure, and the apparatus has the same technical effects as the method according to the present disclosure. Therefore, details of the apparatus may be with reference to the description in the method embodiments of the present disclosure, which are not repeated herein.

An electronic device is further provided according to the present disclosure. The electronic device includes at least one processor and a memory coupled with the at least one processor.

The memory stores a computer program. The computer program, when executed by the at least one processor, causes the processor to perform the method for generating a time series data adversarial sample according to the first aspect of the present disclosure.

The memory may include a read-only memory and a random access memory, and provide instructions and data to the processor. A part of the memory may further include a non-volatile random access memory (NVRAM). The memory stores an operation system and operation instructions, an executable module or a data structure, or a subset thereof, or an extended set thereof. The operation instructions may include various operation instructions for performing various operations. The operation system may include various system programs for implementing various basic services and processing hardware-based tasks.

The processor controls an operation of the electronic device. The processor may also be referred to as central processing unit (CPU). In practical applications, components of the electronic device are coupled through a bus system. In addition to a data bus, the bus system may further include a power bus, a control bus, a state signal bus and the like. However, for clarity, the various buses are referred to as bus system in the Figure.

The method disclosed in the above embodiments of the present disclosure may be applied to a processor or be implemented by the processor. The processor may be an integrated circuit chip with signal processing capability. In implementation, steps of the method may be implemented by a hardware integrated logic circuit or software instructions in the processor. The processor may be a general processor, a digital signal processing (DSP), an application specific integrated circuit (ASIC), a field-programmable gate array (FPGA), a programmable logic devices, an independent gate, a transistor logic device, or an independent hardware component. The methods, steps and logical block diagrams disclosed in the embodiments of the present disclosure may be implemented or performed. The general processor may be a microprocessor, a conventional processor, or the like. Steps of the method disclosed in combination with the embodiments of the present disclosure may be directly implemented by a hardware decoding processor or implemented by a combination of a hardware module and a software module in the decoding processor. The software module may be in a mature storage medium in the art such as a random access memory, a flash memory, a read-only memory, a programmable read-only memory or an electrically erasable programmable memory, or a register. The storage medium is in the memory, and the processor reads information in the memory and performs the steps of the above method in combination with hardware.

The receiver may be configured to receive inputted digital or character information and generate a signal input related to relevant settings and function control of the electronic device. The transmitter may include a display device such as a display screen, and the transmitter may be configured to output a digital or character information through an external interface.

In the embodiments of the present disclosure, the processor is configured to execute the method for generating a time series data adversarial sample performed by the electronic device in the above steps 101 to 104 or 201 to 205.

A computer readable storage medium is further provided according to the present disclosure. The computer readable storage medium stores a computer program. The computer program, when being executed, performs the method for generating a time series data adversarial sample according to the first aspect of the present disclosure.

The above processes are implemented by performing the following operations according to the present disclosure.

1. The method for generating an adversarial sample with global disturbance is provided based on gradient information according to the present disclosure. After adding slight disturbance to the original data, the time series adversarial sample may cause the prediction model to output a wrong result.

2. In order to further reduce disturbance cost, the method for determining an importance of the adversarial sample is provided according to the present disclosure. In the method, samples at important time instants are disturbed to minimize the distance between the adversarial sample and the original data (which is referred to as the method based on local disturbance) with ensuring a required adversarial attack effect.

3. The method is applicable to a certain time series prediction model, and is applicable to other prediction models. The adversarial sample generated for the target model may also be used to attack other time series prediction models.

4. Based on experimental test by using actual data sets, it shows that the provided method may be applied to many prediction models, effectively reducing the accuracy of the target time series prediction model. In addition, an adversarial sample generated for a certain model also has an attack effect on other models, so that the effectiveness and applicability of the method are proved.

In order to illustrate the effectiveness of the method according to the embodiments of the present disclosure, the following three evaluation indicators commonly used in time series data prediction are used in the present disclosure: root relative squared error (RSE), relative absolute error (RAE) and empirical correlation coefficient (CORR). In performing prediction, a smaller error and a larger correlation coefficient indicates a better prediction performance. However, an objective of attacking the prediction model is to achieve an inaccurate prediction, that is, a large error and a small correlation coefficient indicates that the attack according to the method is effective. The three evaluation indicators are expressed as:

$$RSE = \frac{\sqrt{{\sum }_{( i , t ) ∈ {Ω}_{test}} {( {Y}_{it} - {Y}_{it}^{′} )}^{2}}}{\sqrt{{\sum }_{( i , t ) ∈ {Ω}_{test}} {( {Y}_{it} - mean ( Y ) )}^{2}}} .$$

$$RAE = \frac{{\sum }_{( i , t ) ∈ {Ω}_{test}} \vert {Y}_{it} - {Y}_{it}^{′} \vert}{{\sum }_{( i , t ) ∈ {Ω}_{test}} \vert {Y}_{it} - mean ( Y ) \vert} .$$

In the embodiments of the present disclosure, the distance between the adversarial sample and the original data may be measured by using a Frobenius norm (F-norm). In the following experiment, the distance between the time series adversarial sample and the original time series is quantified by using the F-norm, and the distance between the adversarial sample and the original time series data should be as small as possible. F-norm is defined as the following equation:

[symbol]

−Norm=∥\hat{X}−X∥_{F}

Table 1 and Table 2 respectively show performance of performing an adversarial attack on an LSTNet model trained based on [symbol] -Loss and performance of performing an adversarial attack on an LSTNet model trained based on [symbol] -Loss, verifying the effectiveness of the method according to the present disclosure.

TABLE 1
Performance of performing an adversarial attack on
an LSTNet model [symbol] − Loss)

| | | ε | | | | |
|---|---|---|---|---|---|---|
| Datasets | Metrics | 0 | 0.05 | 0.1 | 0.15 | 0.2 |
| Electricity | RSE | 0.1020 | 0.8098 | 0.8502 | 0.8822 | 0.9583 |
| | RAE | 0.0581 | 0.4039 | 0.4460 | 0.4909 | 0.5562 |
| | CORR | 0.8712 | 0.0034 | −0.0085 | 0.0021 | 0.0059 |
| Solar | RSE | 0.4309 | 1.7658 | 2.0727 | 2.2691 | 2.4294 |
| | RAE | 0.2447 | 1.8743 | 2.2089 | 2.4324 | 2.6405 |
| | CORR | 0.9090 | 0.0081 | −0.0028 | −0.0067 | 0.0101 |
| Household | RSE | 0.4960 | 0.8064 | 0.9039 | 1.0157 | 1.1304 |
| | RAE | 0.3209 | 0.5707 | 0.6412 | 0.7335 | 0.8216 |
| | CORR | 0.6236 | 0.0030 | −0.0122 | −0.0317 | 0.0050 |

TABLE 2
Performance of performing an adversarial attack on
an LSTNet model [symbol] − Loss)

| | | ε | | | | |
|---|---|---|---|---|---|---|
| Datasets | Metrics | 0 | 0.05 | 0.1 | 0.15 | 0.2 |
| Electricity | RSE | 0.1016 | 0.8064 | 0.8748 | 0.9425 | 1.0579 |
| | RAE | 0.0595 | 0.4064 | 0.4667 | 0.5416 | 0.6421 |
| | CORR | 0.8758 | 0.0015 | −0.0084 | 0.0016 | 0.0025 |
| Solar | RSE | 0.2716 | 1.4353 | 1.6040 | 1.7569 | 1.8822 |
| | RAE | 0.1688 | 1.4712 | 1.7017 | 1.8830 | 2.0326 |
| | CORR | 0.9648 | 0.0032 | −0.0097 | −0.0095 | 0.0253 |
| Household | RSE | 0.4147 | 0.8124 | 0.8994 | 1.0518 | 1.1743 |
| | RAE | 0.2760 | 0.5621 | 0.6304 | 0.7543 | 0.8613 |
| | CORR | 0.6696 | −0.0315 | −0.0077 | −0.0044 | 0.0037 |

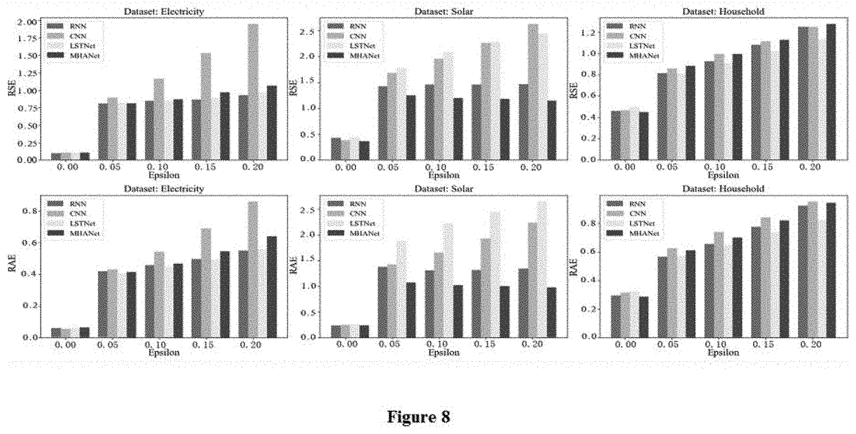

In order to illustrate the applicability of the present disclosure, that is, illustrate whether the method for generating an adversarial sample according to the present disclosure is applicable to other deep neural networks, FIG. 8 shows prediction results of the time series prediction model at different disturbance percentages. FIG. 8 shows RSEs and RAEs of different data sets in different neural networks at disturbance percentages Epsilon of 0.00, 0.05, 0.10, 0.15 and 0.20. The data sets include an Electricity data set, a Solar data set and a Household data set. The neural networks include a RNN, a CNN, an LSTNet and an MHANet. Generally, an error of a prediction method increases as a disturbance percentage increases, showing vulnerability of an advanced time series prediction method to a malicious attack. Based on the observation results, researchers may be motivated to factor safety into design of time series prediction models.

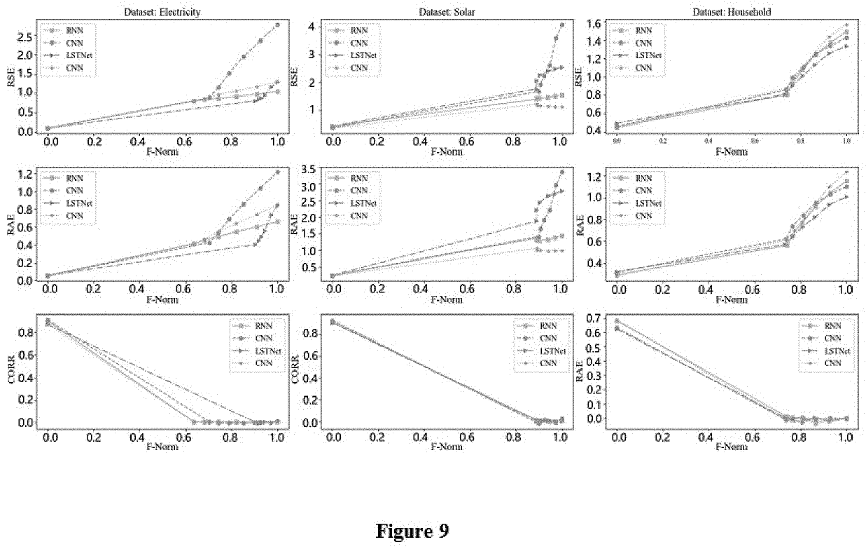

In addition, F-norm is used to quantify the distance between the time series adversarial sample and the original time series. As shown in FIG. 9, FIG. 9 shows RSEs, RAEs and CORRs of different data sets in different neural networks at F-norms ranging from 0.0 to 1.0. The data sets include the Electricity data set, the Solar data set and the Household data set. The neural networks include the RNN, the CNN, the LSTNet and the MHANet. With the increase of F-norm, that is, with the gradual increase of the disturbance percentage, the error of the prediction model increases, and the correlation between the prediction result and the real data is destroyed.

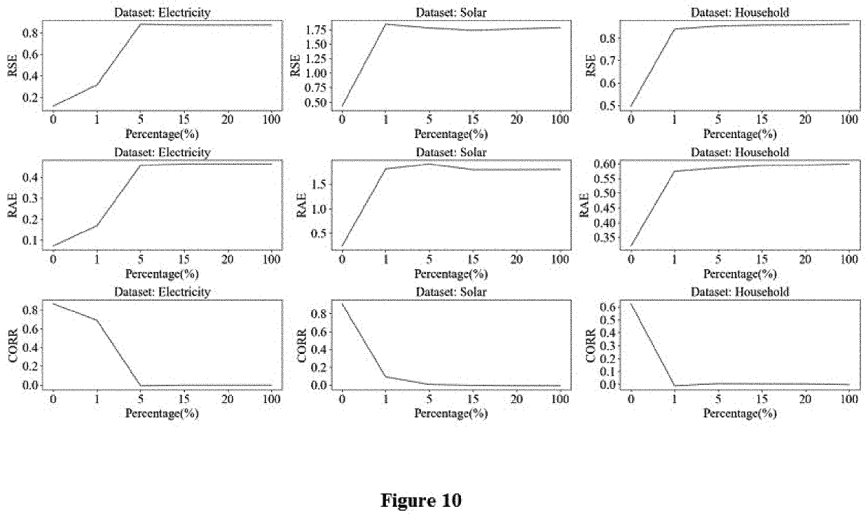

The evaluation of the method for generating a time series adversarial sample with local disturbance is described as follows. The abscissas represent a disturbance percentage (ranging from 0% to 100%) in the method for generating a time series adversarial sample with local disturbance. It should be noted that 0% represents a prediction of the model on the original time series data, and 100% represents a prediction of the model on the time series data based on global disturbance. The ordinates respectively represent one of the three evaluation indicators RSE, RAE and CORR. It can be seen from FIG. 10 that FIG. 10 shows RSEs, RAEs and CORRs of different data sets in different neural networks at different disturbance percentages. The data sets include the Electricity data set, the Solar data set and the Household data set. The neural networks include RNN, CNN, LSTNet and MHANet. In selecting 5% of the adversarial samples based on global disturbance from the Electricity data set to disturb the original time series, a 100% disturbance effect can be achieved. In a case of selecting 1% of the adversarial samples based on global disturbance from the Solar data set or the Household data set to disturb the original time series, a 100% disturbance effect can be achieved. Therefore, with the method for generating a time series adversarial sample with local disturbance, the disturbance cost can be greatly reduced.

In the description of the present disclosure, it should be understood that the azimuth or positional relationship indicated by terms such as “coaxial”, “bottom”, “one end”, “top”, “middle”, “the other end”, “upper”, “one side”, “top”, “inner”, “outer”, “front”, “center”, “two ends” is based on an azimuth or positional relationship shown in the drawings, and is used only for conveniently describing the present disclosure and simplifying the description rather than indicating or implying that the indicated apparatus or element is required to have a specific azimuth, or constructed and operated in a specific azimuth, so that the terms cannot be understood as a limitation of the present disclosure.

In the present disclosure, unless otherwise specified and limited, terms such as “installation”, “arrangement”, “connection”, “fixed”, and “rotation” should be understood in a broad sense. For example, the connection may be fixed connection, removable connection, or integrated connection. The connection may also be mechanical connection or electrical connection. The connection may be direct connection or indirect connection through an intermediate medium. The connection may be communication within two elements or interaction between two elements. Unless otherwise clearly defined, for those skilled in the art, specific meanings of the above terms in the present disclosure should be understood according to specific conditions.

Although the embodiments of the present disclosure are shown and described, it can be understood by those skilled in the art that various changes, modifications, substitutions and variations may be made to the embodiments without departing from the principle and spirit of the present disclosure. The scope of the present disclosure is limited by the claims and equivalents of the claims.

It should be noted that for simple description, the above method embodiments are described as a series of action combinations. However, those skilled in the art should be aware that the present disclosure is not limited by an order of the described actions, because according to the present disclosure, some steps may be performed in other order or simultaneously. In addition, those skilled in the art should also know that the embodiments described in the specification are preferred embodiments, and the actions and modules involved are unnecessary for the present disclosure.

In another possible design, in a case that a single sub device is a chip, the device includes a processing unit and a communication unit. The processing unit, for example, may be a processor. The communication unit, for example, may be an input/output interface, a pin or a circuit. The processing unit may execute computer executable instructions stored in a storage unit to cause the chip in the terminal to perform the method for transmitting wireless report information according to the first aspect. In an embodiment, the storage unit is arranged in the chip, and may be, for example, a register and a cache. The storage unit may be arranged outside a chip and in a terminal, such as a read-only memory (ROM), a static storage device capable of storing static information and instructions, or a random access memory (RAM).

The processor mentioned above may be a general central processing unit, a microprocessor, an ASIC, or one or more integrated circuits for controlling program execution of the above method.

In addition, it should be noted that the device embodiments described above are only schematic. The units described as separate components may be or may not be physically separated. The components displayed as units may be or may not be physical units, that is, may be arranged in the same place or distributed on multiple network units. Some or all of the modules may be selected according to actual needs to achieve the objective of solutions of the embodiments. Moreover, in the drawings of the device embodiments of the present disclosure, connection relationship between modules indicates that the modules are connected in communication, which may be implemented as one or more communication buses or signal lines.

Through the description of the above embodiments, those skilled in the art can clearly understand that the present disclosure may be implemented by means of a combination of software and necessary general hardware. Apparently, the present disclosure may also be implemented by special hardware including a special integrated circuit, a special CPU, a special memory, a special device and the like. Generally, all functions implemented by a computer program may be easily implemented by hardware. In addition, specific hardware used for implementing the same function may has various structures. For example, the hardware may be an analog circuit, a digital circuit, a special circuit or the like. However, for the present disclosure, implementation by a software program is a preferred embodiment in many cases. Based on this understanding, the technical solutions of the present disclosure essentially or a part of the technical solutions that contributes to the conventional technology may be implemented as a software product. The computer software product may be stored in a storage medium, such as a floppy disk, a U disk, a mobile hard disk, an ROM, an RAM, a magnetic disk or an optical disk of a computer. The computer software product includes several instructions executed by a computer device (may be a personal computer, a server, a network device and the like) to implement method according to the embodiments of the present disclosure.

All or part of the above embodiments may be implemented by software, hardware, firmware or any combination thereof. In a case that the embodiments are implemented by software, all or part of the embodiments may be implemented in a form of a computer program product.

The computer program product includes one or more computer instructions. When the computer program instructions are loaded and executed on a computer, all or part of the processes or functions described in the embodiments of the present disclosure are generated. The computer may be a general computer, a special computer, a computer network, or other programmable device. The computer instructions may be stored in a computer readable storage medium or transmitted from a computer readable storage medium to another computer readable storage medium. For example, the computer instructions may be transmitted from a website site, a computer, a server or a data center to another website site, another computer, another server or another data center in a wired manner (for example, through a coaxial cable, optical fiber, and digital subscriber line (DSL)) or in a wireless manner (for example, through infrared, radio, microwave, and the like). The computer readable storage medium may be any available medium that can be stored by a computer, or a data storage device including one or more available media, such as a server and a data center. The available medium may be a magnetic medium (for example, a floppy disk, a hard disk and a magnetic tape), an optical medium (for example, a DVD), a semiconductor medium (for example, a solid state disk (SSD)), or the like.

1. A method for generating a time series data adversarial sample, comprising:
training a time series prediction model by using original time series data;
calculating a maximum value of a loss function in the time series prediction model based on a stochastic gradient descent optimization algorithm;
determining a noise based on the maximum value of the loss function; and
superimposing the noise on the original time series data to generate a time series data adversarial sample with global disturbance.

2. The method for generating a time series data adversarial sample according to claim 1, wherein the calculating a maximum value of a loss function in the time series prediction model based on a stochastic gradient descent optimization algorithm comprises:
determining, based on a direction opposite to a descent direction of a gradient, the maximum value of the loss function in a direction along which the loss function increases fastest.

3. The method for generating a time series data adversarial sample according to claim 1, wherein the determining a noise based on the maximum value of the loss function comprises:
calculating a gradient of the loss function by using a symbolic function;
determining a linear noise parameter based on a maximum disturbance and an iteration number; and
determining a maximum value of a product of the linear noise parameter multiplied by the calculated gradient as the noise.

4. The method for generating a time series data adversarial sample according to claim 3, wherein the linear noise parameter is equal to a ratio of the maximum disturbance to the iteration number.

5. The method for generating a time series data adversarial sample according claim 1, wherein after generating the time series data adversarial sample with global disturbance, the method further comprises:
calculating a first importance at each of time instants in the time series data adversarial sample and a second importance at each of time instants in the original time series data;
calculating, at each of corresponding time instants, a distance between a first importance at the time instant and a second importance at the time instant;
sorting distances at all corresponding time instants in a descending order to determine first several time instants; and
replacing, by using data at the first several time instants in the generated time series data adversarial sample with global disturbance, data at corresponding time instants in the original time series data to generate a time series data adversarial sample with local disturbance.

6. A system for generating a time series data adversarial sample, comprising:
a model training module, configured to train a time series prediction model by using original time series data;
a data disturbance module, configured to calculate a maximum value of a loss function in the time series prediction model based on a stochastic gradient descent optimization algorithm and determine a noise based on the maximum value of the loss function; and
a sample generation module, configured to superimpose the noise determined by the data disturbance module on the original time series data to generate a time series data adversarial sample with global disturbance.

7. The system for generating a time series data adversarial sample according to claim 6, further comprising:
a data adjustment module, configured to select data at several time instants from the time series data adversarial sample with global disturbance and replace data at corresponding time instants in the original time series data with the selected data to generate a time series data adversarial sample with local disturbance.

8. The system for generating a time series data adversarial sample according to claim 7, further comprising:
a similarity calculation module, configured to calculate a first importance at each of time instants in the time series data adversarial sample and a second importance at each of time instants in the original time series data, calculate, at each of corresponding time instants, a distance between a first importance at the time instant and a second importance at the time instant, and sort distances at all corresponding time instants in a descending order to determine first several time instants.

9. An electronic device, comprising:
at least one processor, and
a memory coupled with the at least one processor, wherein
the memory stores a computer program, and the computer program, when executed by the at least one processor, causes the processor to perform the method for generating a time series data adversarial sample according to claim 1.

10. A computer readable storage medium storing a computer program, wherein the computer program, when executed, performs the method for generating a time series data adversarial sample according to claim 1.
